(19) United States
(12) Patent Application Publication
(10) Pub. No.: US 2002/0126317 A1
(43) Pub. Date: Sep. 12, 2002

(54) Facsimile transmission method and system

(76) Inventors: Mikko Ohvo, Numminen (FI); Juha Rasanen, Espoo (FI); Markku Tuomi, Espoo (FI)

Correspondence Address: ALTERA LAW GROUP, LLC, 6500 CITY WEST PARKWAY, SUITE 100, MINNEAPOLIS, MN, 55344, US

(21) Appl. No.: 09/843,193

(22) Filed: Apr. 26, 2001

Related U.S. Application Data
(63) Continuation of application No. PCT/EP98/08254, filed on Dec. 16, 1998.

(51) Int. Cl. H04N 1/00

(52) U.S. Cl. 358/402

(57) ABSTRACT

A method and apparatus for transmitting a facsimile message via a communication network is described, wherein the facsimile message is at least partly transmitted to the called party using an agreed file transfer protocol. When a negotiating step was not successful, the facsimile message is transmitted using a normal facsimile protocol. Thus, the use of file transfer protocol is allowed as a means for transferring facsimile message data, such that a facsimile transmission via packet-switched networks like the Internet can be provided. With modem types other than those defined especially for facsimile use, the date transfer speed is remarkably higher, such that lower transmission costs can be achieved.

### FIELD OF THE INVENTION

The present invention relates to a method and system for transmitting a facsimile message via a communication network such as a PSTN (Public Switched Telephone Network), a PLMN (Public Land Mobile Network) and/or an ISDN (Integrated Services Digital Network).

### BACKGROUND OF THE INVENTION

Procedures allowing the technical realisation of a group 3 facsimile service within the GSM; (Global System for Mobile Communications) PLMN using transparent network support are defined in the teleservice TS62 as specified in GSM 02.03. The teleservice TS62 (Automatic facsimile group 3) will most probably be implemented in third generation mobile networks by using a so-called store and forward concept. According to this concept, a facsimile message is transferred with a normal file transfer method between a mobile switching center (MSC) and a mobile station (MS). The use of such a file transfer method provides the advantage that the need for a facsimile adapter in the MSC is eliminated and the problems caused by tight protocol timers ruled by a fixed network facsimile protocol can be removed.

The store and forward concept may be implemented by providing a store and forward service center (S&FW service center) as a static network element with predefined operations and functionality, or as a member of a mobile execution environment (MeXe) concept or a network execution environment (NeXe) concept where applications can be loaded dynamically both to the MS and a network service center.

However, the store and forward concept requires a new network function for storing and forwarding received facsimile messages either to the MS or to the fixed network.

In the following, the functionality of the store and forward facsimile service is described.

In a mobile terminated facsimile call with store and forward concept, the PSTN facsimile apparatus calls the MS or a facsimile box of the subscriber in the S&FW center. The call is forwarded by the MSC to the S&FW service center which handles the facsimile transmission to the PSTN facsimile apparatus by using a facsimile protocol defined in CCITT T.30.

After the facsimile message has been received in the S&FW service center, the S&FW service center may either send an SMS (Short Message Service) message to the MS in order to inform the MS about the received facsimile message, or start sending the received facsimile message direct to the MS as a file. In the former case, the MS retrieves the facsimile message as a file by making a data call to the S&FW center. In the latter case, the MS equipment has to be able to always receive facsimile messages without any additional operation, which can be achieved by an integrated solution of the MS and a corresponding terminal equipment (TE).

In case of a mobile originated facsimile call with store and forward concept, the MS initiates a call setup which indicates the demand for the S&FW center either with the setup signaling (BCIE parameters) or by calling the number of the S&FW service center. Thereafter, the facsimile transmission between the MS and the S&FW center is carried out as a file transfer. The actual destination of the facsimile message is indicated to the S&FW service center either by the setup signaling or by in-band parameters sent during the file transfer.

After the facsimile message has been received by the S&FW center, it sends the facsimile message to the indicated number using the T.30 facsimile protocol.

However, the transmission rate of a group 3 facsimile message is limited by the T.30 facsimile protocol to 14.4 kbit/s. Since the facsimile message is transmitted from the S&FW service center to a called PSTN facsimile apparatus or to a S&FW service center of a called MS, and vise versa, using the standard facsimile operation defined in T.30, the facsimile message transfer speed is low, resulting in higher transmission costs.

### SUMMARY OF THE INVENTION

It is therefore an object of the present invention to provide a method and system for transmitting a facsimile message, by means of which transmission costs can be reduced.

This object is achieved by a method for transmitting a facsimile message via a communication network, comprising the steps of:

negotiating the use of a file transfer method with a called party;

transmitting the facsimile message to the called party using an agreed file transfer protocol, when the negotiating step was successful; and

transmitting the facsimile message to the called party using a facsimile protocol, when the negotiating step was not successful.

Accordingly, the problem of low facsimile message transfer speed is solved by allowing the use of file transfer protocols for transferring facsimile message data. With other modem types then those specifically defined for facsimile use, a remarkably higher date transfer speed can be achieved, which results in lower transmission costs.

Moreover, with a digital transmission, the achieved data transfer rate is even higher than with modems. For example by using a V.120 protocol, the user data rate can be up to 64 kbit/s minus a framing overhead.

The negotiating step may be performed by using a control field of a message frame of the facsimile protocol. In case of the T.30 facsimile protocol, the control field may be the NSF field of the DIS/DTC frame. Thus, the use of a file transfer method can be negotiated by using a message frame already provided in the facsimile protocol, to thereby minimize required modifications.

Preferably, the called party may use the control field to indicate a possible file format and a file transfer method.

The transmitting step can be performed by setting up the agreed file transfer protocol, carrying out further parameter negotiations in-band, and starting file transfer after link setup and in-bound parameter negotiation.

Furthermore, the negotiation step may comprise trying to set up a file transfer protocol when said called party has answered, and waiting for an acknowledgement from the called party. In this case, the file transfer protocol may be a V.120 protocol, for example, wherein a SABM message is sent to the called party to try to set up the V.120 protocol. Subsequently, the transmission of the facsimile message is done as a file transfer using the V.120 protocol, when an acknowledgement has been received in response to said SABM message. If no answer has been received after a predetermined time period, a modem or facsimile calling tone is sent in order to set up a modem or facsimile connection.

Furthermore, the called party may answer a frequency of a calling modem with its normal modem frequency, wherein a modem handshake is started, when the calling modem accepts the answer signal, and wherein the negotiating step is performed, when the calling modem does not accept the answer signal. Thereby, a modem handshaking can be started instead of a facsimile mode modem handshake, before negotiating the file transfer. The use of the normal modem instead of the facsimile modem also leads to a higher transmission speed.

Additionally, the above object is achieved by a transmitting apparatus for transmitting a facsimile message via a communication network, comprising:

negotiating means for negotiating the use of a file transfer method with a called party,

transmitting means responsive to the negotiating means, for transmitting the facsimile message to the called party using an agreed file transfer protocol, when the negotiation was successful, and for transmitting the facsimile message to the called party using a facsimile protocol, when the negotiation was not successful.

The transmitting apparatus may be a PSTN facsimile apparatus or a store and forward service center.

The negotiating means may be arranged to send an SABM message of the V.120 protocol to the called party, wherein the negotiation is judged as being successful, when the negotiating means receives an acknowledgement in response to the SABM message.

The negotiating means can be arranged to use a control field of a message frame of the facsimile protocol in order to negotiate the use of the file transfer method.

Furthermore, the above object is achieved by a receiving apparatus for receiving a facsimile message via a communication network, comprising:

negotiating means for negotiating the use of a file transfer method with a calling party, and

receiving means responsive to the negotiating means, for receiving the facsimile message from the calling party using an agreed file transfer protocol, when the negotiation was successful, and for receiving the facsimile message from the calling party using a facsimile protocol, when the negotiation was not successful.

The negotiating means can be arranged to send an acknowledgement, when a setup command of a file transfer protocol has been received, and to subsequently set up the file transfer protocol.

Furthermore, the negotiation means may be arranged to set up a modem or facsimile connection, when a modem or a facsimile calling tone, respectively, has been received.

Moreover, the negotiating means may be arranged to answer a received calling modem frequency with its normal modem frequency, and to start a modem handshake, when the calling modem accepts the answer signal.

The communication network may also comprises an RLL or WLL network.

Additionally, the above object is achieved by a method for transmitting a facsimile message via a communication network to a subscriber, comprising the steps of:

allocating an identification number provided in a store and forward center to the subscriber;

transmitting the facsimile message to the store and forward center by using an agreed file transfer protocol.

Accordingly, a facsimile message is transmitted from one subscriber to another subscriber via two store and forward centers, wherein a file transfer is performed between the two store and forward centers. Thus, transmission costs can be reduced due to the fast file transfer between the two store and forward centers.

The subscriber may be a subscriber of a fixed network. Thus, a file transfer is performed between the respective store and forward service centers allocated to the PSTN subscribers, such that a major distance of long distance calls between two PSTN subscribers can be covered by the fast file transfer.

The transmission of the facsimile message from the store and forward center to the subscriber may be performed in dependence on the capability of a subscriber terminal of the subscriber. Thus, if the subscriber terminal is a mobile terminal, a file transfer can be performed. Otherwise, a facsimile or modem transmission can be negotiated.

The facsimile message may include an identification of the store and forward center and an identification of the subscriber. Thereby, the required routing informating is directly transmitted to the store and forward centers.

Alternatively, the facsimile message may include an identification of the subscriber, wherein an identification of the store and forward center is determined on the basis of a routing information provided at a store and forward center allocated to a subscriber from which the facsimile message is transmitted. Thus, by providing a routing information at the store and forward centers, only the identification of the subscriber has to be transmitted with the facsimile message.

In general, the use of the agreed file transfer protocol enables a facsimile transmission via a packet-switched network.

### BRIEF DESCRIPTION OF THE DRAWINGS

In the following, the present invention will be described in greater detail on the basis of a preferred embodiment with reference to the accompanying drawings, in which:

FIG. 1 shows a principle block diagram of a mobile communication network connected to a PSTN and in which the method and system according to the preferred embodiment of the present invention are implemented,

FIG. 2 shows a functional block diagram of a transmitter or receiver according to the preferred embodiment of the present invention,

FIG. 3 shows a flow diagram of a facsimile transmission method according to the preferred embodiment of the invention,

FIG. 4 shows flow diagram of another example of a facsimile transmission method according to the preferred embodiment of the present invention, and

FIG. 5 shows a further example of a facsimile transmission method according to the preferred embodiment of the present invention.

### DESCRIPTION OF THE PREFERRED EMBODIMENT

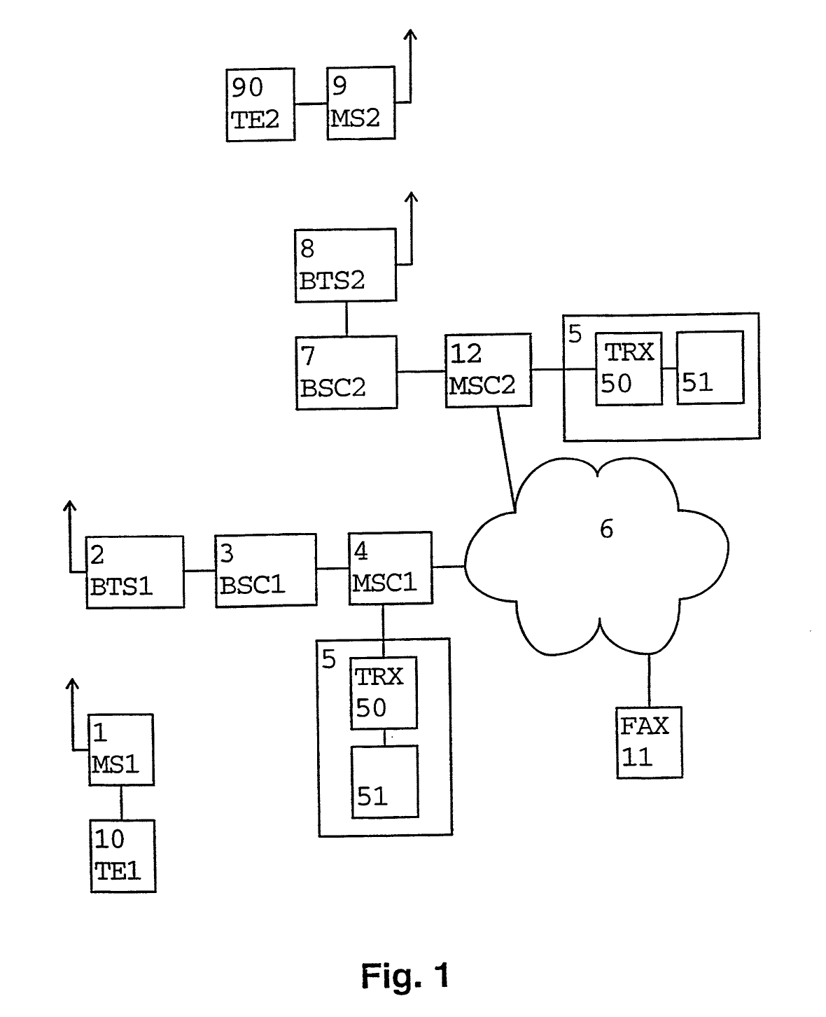

In the following, the preferred embodiment of the method and system according to the present invention will be described on the basis of a mobile communication network connected to a fixed network (PSTN) 6, as shown in FIG. 1.

According to FIG. 1, a first mobile station (MS1) 1 having a terminal equipment (TE1) 10 with a facsimile transmission capability is radio-connected to a first base transceiver station (BTS1) 2. The first base transceiver station 2 is connected via a base station controller (BSC1) 3 to a mobile switching center (MSC) 4 arranged to switch a call either to the fixed network or PSTN 6 or to a second mobile switching center (MSC2) 12 connected to a second base station controller (BSC2) 7 controlling a second base transceiver station (BTS2) 8. Furthermore, a second mobile station (MS2) 9 having a terminal equipment (TE2) 90 with a facsimile transmission capability is radio-connected to the second base transceiver station (BTS2) 8.

A facsimile transmission via the mobile communication network and/or the PSTN 6 is enabled by providing respective store and forward service centers (S&FW service centers) 5 connected to the first and second mobile switching centers 4 and 12. Each S&FW service center 5 comprises a transceiver (TRX) 50 connected to a memory 51, so as to store and forward received facsimile messages either to one of the first and second MSs 1 and 9 or to a facsimile apparatus (FAX) 11 connected to the PSTN 6. The transceiver 50 may as well be replaced by a separate transmitter and receiver.

According to the preferred embodiment of the present invention, the facsimile transmission between the first mobile station 1 or the second mobile station 9 and the S&FW service center 5 is done by a digital file transmission or file transfer within a normal data call. Additionally, an optional file transfer is performed between the S&FW service center 5 and the facsimile apparatus 11, which may be a G3 facsimile machine, or another S&FW service center.

To achieve this, the transceiver 50 is arranged to select a facsimile protocol or a file transfer protocol on the basis of a preceding negotiation with the corresponding other party. Thereby, the transmission rate in a mobile to mobile facsimile call can be increased. Additionally, the transceiver 50 may be provided in the facsimile apparatus 11, so as to provide a facsimile file transmission via the PSTN 6, to thereby increase the transmission rate even in a mobile to fixed or fixed to fixed facsimile call.

Moreover, in a Radio Local Loop (RLL) or Wireless Local loop (WLL) service, radio systems are used to replace fixed cables providing access to telecommunications services. In such a case, the facsimile apparatus 11, e.g. a traditional G3 device, can be connected to a GSM-based RLL or WLL system, wherein the facsimile transmission from or to the facsimile apparatus is performed as a file transfer.

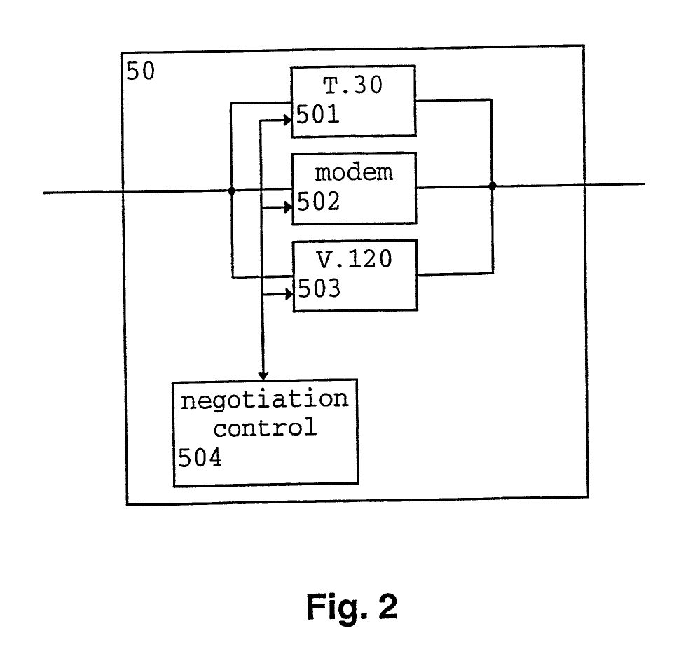

FIG. 2 shows a functional block diagram of the transceiver 50. According to FIG. 2 a negotiation control function 504 is provided, which controls a T.30 transceiving function 501 for performing transmission/reception based on the T.30 protocol, a modem transceiving function 502 for performing a modem transmission/reception, and a V.120 transceiving function 503 for performing a digital transmission/reception based on the V.120 protocol.

According to the following different operating examples of the preferred embodiment, the negotiation control function 504, which may be a CPU having a memory in which a control program is stored, initially performs a negotiation using one of the three facsimile transceiving functions 501, 502, 503, and decides on the basis of negotiation which of the facsimile transceiving functions 501, 502, 503 is to be used for the facsimile transmission to the other party.

In case of a mobile to mobile facsimile call with store and forward concept, the first mobile station 1 performs a facsimile call to the S&FW service center 5 using file transfer. The facsimile message is stored in the S&FW service center 5. Then, the S&FW service center 5 transmits the received facsimile message to the second mobile station 9. Since the second mobile station 9 is arranged to use the S&FW service center 5 of the second mobile switching center 12, either the called number is the number of a facsimile box of the second mobile station 9 in the memory 51 of the allocated S&FW service center 5, or the call is forwarded to the corresponding S&FW service center 5. The facsimile transmission between the transceivers of the respective S&FW centers 5 is performed as a file transfer agreed on the basis of a negotiation (later described) between the respective transceivers.

In case of a facsimile message transfer between the S&FW service center 5 and the facsimile apparatus 11 of the PSTN 6, the facsimile message may also be transferred as a file, if the facsimile apparatus 11 comprises a transceiver 50 as depicted in FIG. 2, which is capable of providing file transfer and negotiating on the use of such a file transfer.

Even if two facsimile apparatuses like the facsimile apparatus 11 comprising the above transceiver are connected to the PSTN 6, a file transfer may be negotiated and used for transmitting a facsimile message between the two PSTN facsimile apparatuses, to thereby achieve an increased transmission speed. In this case, the facsimile message may also be transmitted via a packet-switched network such as the Internet.

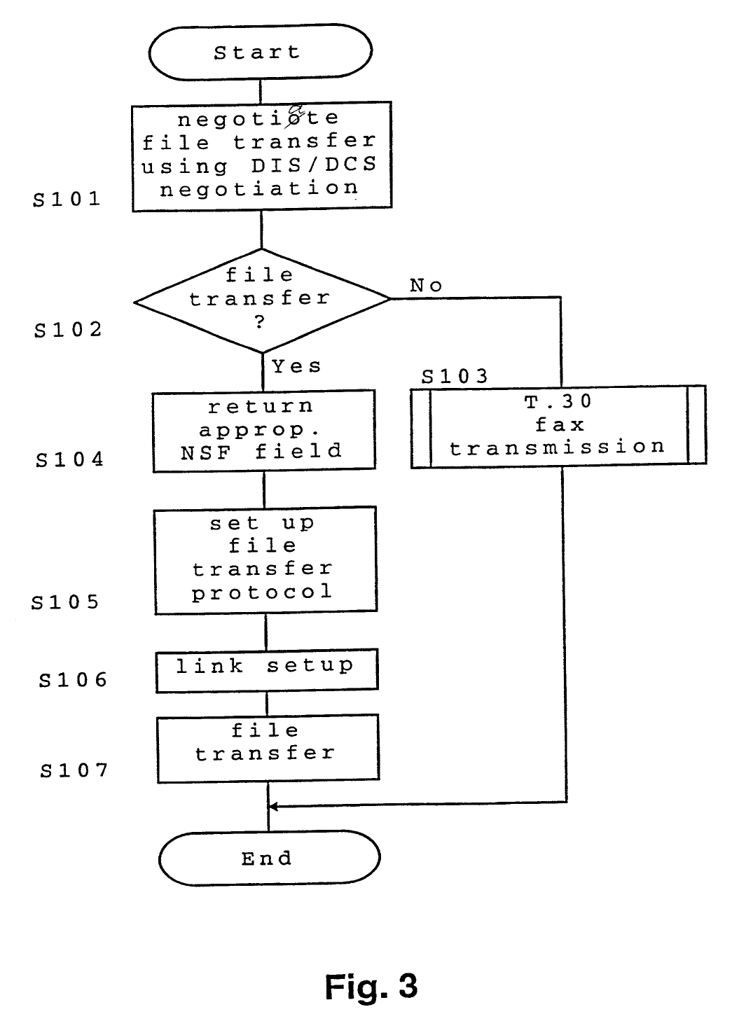

FIGS. 3 to 5 show flow diagrams of different ways of implementing the negotiation performed by the negotiation control function 504 of the transceiver 50 and concerning the use of a file transfer in a facsimile transmission.

According to FIG. 3, the negotiation control function 504 controls the T.30 transceiver function 501 so as to negotiate a file transfer using e.g. the NSF (Non-Standard Facilities) field of the DIS/DCS negotiation (step S101). Thereafter, the answering entity indicates its capabilities such as a possible file format and a transfer method (modem, V.120, etc.) in the returned NSF field.

If it is determined in step S102 that the other end of transmission is not capable of using file transfer for a facsimile message, the negotiation control function 504 controls the T.30 transceiver function 501 so as to perform a T.30 facsimile transmission (step S103).

On the other hand, if the other transmission end is capable of using file transfer for facsimile transmission, the negotiation control function 504 controls the T.30 transceiver function 501 so as to return an appropriate NSF field in a return message defined in the T.30 protocol, if a file transfer with any of the proposed methods is possible (step S104). Subsequently, the negotiation control function 504 controls the respective one of the receiver functions 502 and 503 in order to set up the agreed protocol (step S105), wherein further parameter negotiations are carried out by an in-band signaling.

After a link setup by the corresponding transceiver function (step S106) and possible parameter negotiations, the file transfer of the facsimile message is performed (step S107).

Hence, a file transmission of a facsimile message can be selected on the basis of the capabilities of the other party.

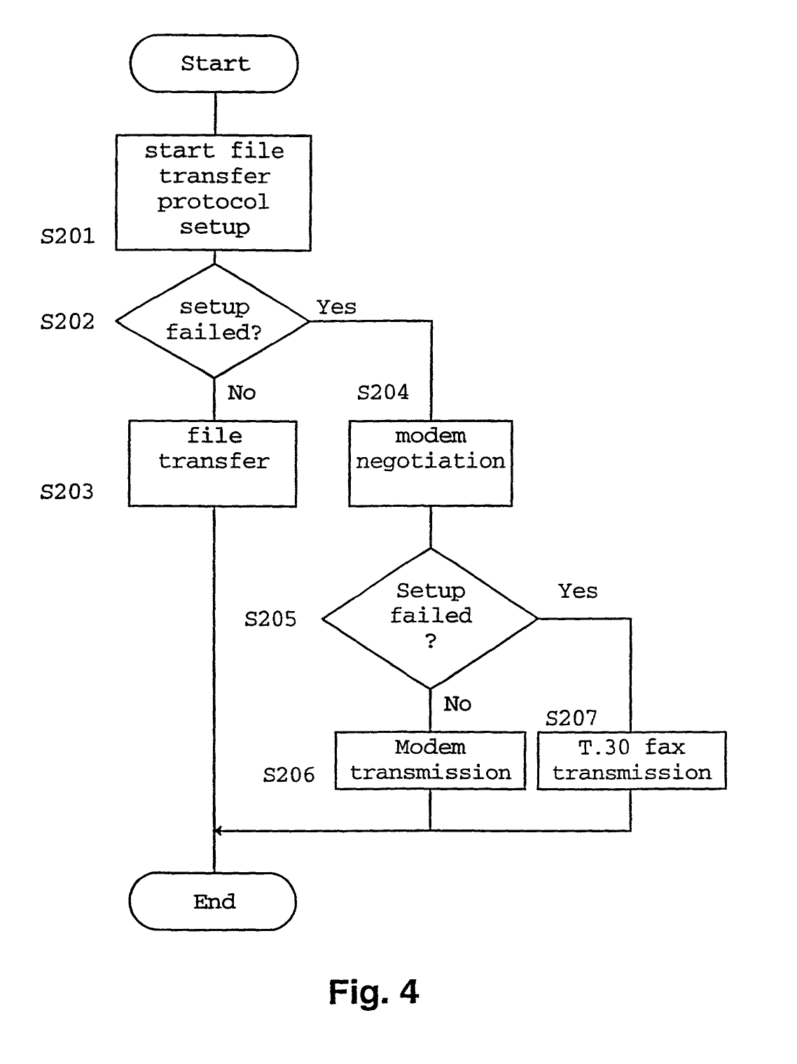

FIG. 4 shows another example of the negotiation performed by the negotiation control function 504.

According to FIG. 4, a file transfer protocol, for example V.120, is tried to set up as soon as the called party has answered a call (step S201). Thereafter, it is checked in step S202 whether the setup has failed or not. In case of using the V.120 protocol, the negotiation control function 504 may control the V.120 transceiving function 503 so as to transmit an SABM (Set Asynchronous Balanced Mode) command. If an acknowledgement UA(Unnumbered Acknowledge) has been received in response to the transmitted SABM command, the negotiation control function 504 judges a successful setup and the transmission of the facsimile message is done as a file transfer (step S205).

On the other hand, if no answer is received within a predetermined time period, the negotiation control function 504 controls the modem transceiver function 502 so as to transmit a modem calling tone, in order to initiate a modem negotiation (step S206). If no answer is received, the negotiation control function 504 judges in step S207 that the setup has failed and controls the T.30 transceiver function 501 to start a normal T.30 facsimile transmission (step S209). If an answer to the modem calling tone has been received within a predetermined time period, the negotiation control function 504 judges in step S207 a successful setup and controls the modem transceiver function 502 so as to perform a modem transmission (step S208).

Thus, the usual and slower T.30 facsimile transmission is only performed if both the V.120 setup and the modem setup have been failed.

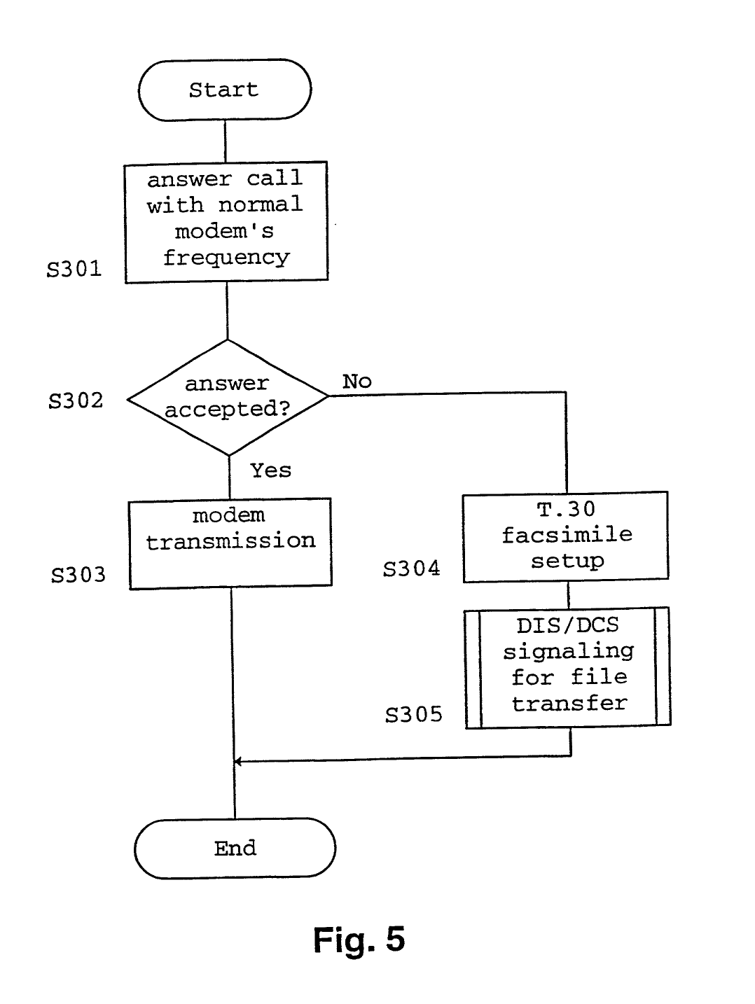

A further example of the negotiation processing performed by the negotiation control function 504 is shown in FIG. 5, where the transceiver 50 receives a normal calling frequency according to the T.30 protocol.

According to FIG. 5, the negotiation control function 504 controls the modem transceiver function 502 so as to answer the received calling frequency with its normal modem frequency (step S301) in order to start a modem handshaking instead of a facsimile mode modem handshake.

In step S302, the negotiation control function 504 performs a check whether the transmitted answer signal has been accepted by the other party. If the other party accepts the answer signal, a modem handshake is started in order to perform a modem transmission (step S303) to thereby achieve a better transmission speed.

If the other party does not accept the answer signal, the negotiation control function 504 controls the T.30 protocol transceiver function so as to perform a T.30 facsimile transmission setup (step S304), wherein the DIS/DCS signaling based on the NSF field is performed so as to negotiate a file transfer as described in connection with FIG. 3 (step 305).

Accordingly, by providing the negotiation control function 504 for selecting between the different transceiver functions 501 to 503, a modem type other than that defined specifically for facsimile use can be provided for transmitting a facsimile message so as to achieve a remarkably higher data transfer speed and thus lower transmission costs. Moreover, in case of a digital file transfer, such as the V.120 protocol, the data rate can be made even higher than with a modem.

Furthermore, in case subscriber identifications such as MSISDN (Mobile Station ISDN) numbers used in the S&FW service center 5 are allocated not only to mobile subscribers, but also to PSTN subscribers, the S&FW service center 5 may even be used in a normal facsimile transmission between PSTN subscribers. In this configuration, the advantage results from the facsimile transmission between two F&SW service centers 5. As an example, a facsimile message could be sent from a first country to a second country, wherein an expensive long distance fee would normally be charged to the calling subscriber. However, in the present case, a file transfer can be implemented by using two S&FW centers 5, one in each subscriber's home country (first and second country). The facsimile transmission would then be performed as follows:

1. The facsimile message is sent from the calling subscriber of the first country to the nearest S&FW service center 5 by using a facsimile message protocol defined in CCITT T.30. This facsimile message includes a target address (phone number) of the S&FW service center 5 allocated to the actually called subscriber and the phone number of the actually called subscriber. Alternatively, the facsimile message includes only the phone number of the actually called subscriber. In this case, the facsimile message can be routed to the S&FW service center 5 of the actually called subscriber, e.g. by IN (Intelligent Network) services or by a configurable routing table in the S&FW service center 5 allocated to the calling subscriber.

2. The S&FW center 5 allocated to the calling subscriber i.e. the calling S&FW service center, sends the facsimile message to the S&FW service center 5 allocated to the called subscriber, i.e. the called S&FW service center, by using a file transfer. If the calling S&FW service center has only switched connections available towards the called S&FW service center, the facsimile message is transferred through a CS (Circuit-Switched) connection (either by a modem or an UDI (Unrestricted Digital Information) service). If both S&FW service centers are connected to the Internet or some other PS (Packet-Switched) network, the facsimile message can be transferred through the PS network between the two S&FW service centers, wherein the identification of the actually called subscriber, i.e. phone number or some other ID, may also be included in the message.

3. Finally, the called S&FW service center sends the facsimile message to the facsimile apparatus of the called subscriber by using the facsimile message protocol defined in T.30.

Accordingly, a high speed facsimile transmission may even be provided over a major distance between two usual PSTN facsimile apparatuses.

In case the transceiver 50 is provided in the S&FW service centers and the facsimile apparatuses, the kind of transmission performed in the above described steps 1 and 3 may also be negotiated as described in connection with FIGS. 3 to 5. Thereby, the transmissions in steps 1 and 3 can be performed in dependence on the capability of the subscriber terminal receiving the facsimile message. Moreover, if the subscriber is a mobile subscriber, a file transfer is performed between the mobile subscriber and the respective store and forward center or vise versa.

It is to be pointed out, that the facsimile transmission method and apparatus described in the preferred embodiment is not restricted to the above described specific facsimile, modem and file transfer protocols, but any such protocol can be used in the present invention. Moreover, the present invention can be used in various communication networks to which a facsimile apparatus may be connected. Additionally, any kind of signaling provided in the corresponding facsimile protocol can be used for negotiating a modem transmission or file transfer.

Thus, the above description of the preferred embodiment and the accompanying drawings are only intended to illustrate the present invention. The preferred embodiment of the invention may vary within the scope of the attached claims.

In summary, a method and apparatus for transmitting a facsimile message via a communication network is described, wherein the facsimile message is at least partly transmitted to the called party using an agreed file transfer protocol. When a negotiating step was not successful, the facsimile message is transmitted using a normal facsimile protocol. Thus, the use of file transfer protocol is allowed as a means for transferring facsimile message data, such that a facsimile transmission via packet-switched networks like the Internet can be provided. With modem types other than those defined especially for facsimile use, the date transfer speed is remarkably higher, such that lower transmission costs can be achieved.

1. A method for transmitting a facsimile message via a communication network, comprising the steps of:
a) negotiating the use of a file transfer method with a called party;
b) transmitting said facsimile message to said called party using an agreed file transfer protocol, when said negotiation step was successful; and
c) transmitting said facsimile message to said called party using a facsimile protocol, when said negotiating step was not successful.

2. A method according to claim 1, wherein said negotiating step is performed by using a control field of a message frame of said facsimile protocol.

3. A method according to claim 2, wherein said facsimile protocol is the T.30 protocol and said control field is an NSF field of a DIS/DTC frame.

4. A method according to claim 2 or 3, wherein said call party uses said control field to indicate a possible file format and a file transfer method.

5. A method according to anyone of the preceding claims, wherein said transmitting step b) is performed by setting up the agreed file transfer protocol, carrying out further parameter negotiations in-band, and starting file transfer after link setup and in-band parameter negotiation.

6. A method according to claim 1, wherein said negotiating step comprises trying to set up a file file transfer protocol, when said call party has answered, and waiting for the receipt of an acknowledgement from the called party.

7. A method according to claim 6, wherein said file transfer protocol is the V.120 protocol, and wherein an SABM message is transmitted to the called party in order to try to set up said V.120 protocol, and wherein a transmission of said facsimile message is done as a file transfer using said V.120 protocol, when an acknowledgement has been received in response to said SABM message.

8. A method according to claim 6 or 7, wherein a modem or facsimile calling tone is transmitted in order to set up a modem or facsimile connection, when no answer has been received after a predetermined time period.

9. A method according to claim 1, further comprising the steps of answering a frequency of a calling modem with a normal modem frequency, selecting a modem handshake, when the answer signal is accepted, and performing said negotiating step, when said answer signal is not accepted.

10. A method according to any one of the preceding claims, wherein said communication network comprises an RLL or WLL network.

11. A method according to any one of the preceding claims, wherein said transmission using said agreed file transfer protocol is performed via a packet-switched network.

12. A method for transmitting a facsimile message via a communication network to a subscriber, comprising the steps of:
a) allocating an identification number provided in a store and forward center to said subscriber; and
b) transmitting said facsimile message to said store and forward center by using an agreed file transfer protocol.

13. A method according to claim 12, wherein said subscriber is a subscriber of a fixed network.

14. A method according to claim 12 or 13, wherein the kind of transmission of said facsimile message from said store and forward center to said subscriber depends on the capability of a subscriber terminal of said subscriber.

15. A method according to any one of claims 12 to 14, wherein said facsimile message includes an identification of said store and forward center and an identification of said subscriber.

16. A method according to any one of claims 12 to 14, wherein said facsimile message includes an identification of said subscriber, and wherein an identification of said store and forward center is determined on the basis of a routing information provided at a store and forward center allocated to a subscriber from which said facsimile message is transmitted.

17. A method according to any one of claims 12 to 16, wherein said transmission using said agreed file transfer protocol is performed via a packet-switched network.

18. A transmitting apparatus for transmitting a facsimile message via a communication network, comprising:
a) negotiating means (504) for negotiating the use of a file transfer method with a called party;
b) transmitting means (501 to 503) responsive to said negotiating means (504), for transmitting said facsimile message to said called party using an agreed file protocol, when the negotiation was successful, and for transmitting said facsimile message to said called party using a facsimile protocol, when said negotiation was not successful.

19. An apparatus according to claim 18, wherein said transmitting apparatus is a PSTN facsimile apparatus (11).

20. An apparatus according to claim 18, wherein said transmitting apparatus is a store and forward service center (5).

21. An apparatus according to anyone of claims 18 to 20, wherein said negotiating means (504) is arranged to control said transmitting means (501 to 503) to transmit a SABM message of the V.120 protocol to said called party, and wherein said negotiation is judged as being successful, when said negotiation means (504) receives an acknowledgement in response to said SABM message.

22. An apparatus according to anyone of claims 18 to 20, wherein said negotiation means (504) is arranged to use a control field of a message frame of said facsimile protocol in order to negotiate the use of said file transfer method.

23. A receiving apparatus for receiving a facsimile message via a communication network, comprising:
a) negotiating means (504) for negotiating the use of a file transfer method with a calling party; and
b) receiving means (501 to 503) responsive to said negotiation means (504) for receiving said facsimile message from said calling party using an agreed file transfer protocol, when the negotiation was successful, and for receiving said facsimile message from said calling party using a facsimile protocol, when said negotiation was not successful.

24. An apparatus according to claim 23, wherein said negotiating means (504) is arranged to control said receiving means (501 to 503) to transmit an acknowledgement, when a setup command of a file transfer protocol has been received, and to subsequently set up said file transfer protocol.

25. An apparatus according to claim 23 or 24, wherein said negotiating means (504) is arranged to control said receiving means (501 to 503) to set up a modem or facsimile connection, when a modem or, respectively, a facsimile calling tone has been received.

26. A method according to claim 23 or 24, wherein said negotiating means (504) is arranged to answer a received calling modem frequency with its normal modem frequency, and to start a modem handshake, when the calling modem accepts the answer signal.
